(19) United States
(12) Patent Application Publication
(10) Pub. No.: US 2024/0216857 A1
(43) Pub. Date: Jul. 4, 2024

(54) METHOD FOR MANUFACTURING A DELIQUESCENT DESICCANT MATERIAL, DELIQUESCENT DESICCANT MATERIAL AND USE THEREOF FOR DRYING GASES

(71) Applicants: PETRÓLEO BRASILEIRO S.A. – PETROBRAS, Rio de Janeiro (BR); UNIVERSIDADE FEDERAL DE MINAS GERAIS - UFMG, Belo Horizonte (BR)

(72) Inventors: WANDER LUIZ VASCONCELOS, Nova Lima (BR); LEONARDO DOS SANTOS PEREIRA, Rio de Janeiro (BR); JÉSSICA DE OLIVEIRA NOTÓRIO RIBEIRO, Ijaci (BR); JAILTON FERREIRA DO NASCIMENTO, Rio de Janeiro (BR); DANIELA CORDEIRO LEITE VASCONCELOS, Nova Lima (BR); PRISCILA CRISTH FONSECA ALVES, Belo Horizonte (BR); DARLEY CARRIJO DE MELO, Rio de Janeiro (BR); DÉBORA GUIMARÃES DA SILVA, Pará de Minas (BR)

(73) Assignees: PETRÓLEO BRASILEIRO S.A. – PETROBRAS, Rio de Janeiro (BR); UNIVERSIDADE FEDERAL DE MINAS GERAIS - UFMG, Belo Horizonte (BR)

(21) Appl. No.: 18/394,356

(22) Filed: Dec. 22, 2023

(30) Foreign Application Priority Data
Dec. 28, 2022 (BR) 1020220268568

(51) Int. Cl. B01D 53/28; B01D 53/26; B01J 20/10; B01J 20/28; B01J 20/30

(52) U.S. Cl. CPC B01D 53/28; B01D 53/263; B01J 20/103; B01J 20/28059; B01J 20/28061; B01J 20/3078; B01D 2253/106; B01D 2253/306; B01D 2257/80; B01J 2220/42

(57) ABSTRACT

The present invention relates to a method for manufacturing a deliquescent desiccant material, preferably for the dehydration of natural gas, which comprises the steps of (a) preparing a solution comprising water, alcohol, a weak base and a deliquescent salt; (b) stirring the solution obtained in (a) until complete dissolution of the deliquescent salt; (c) adding a silica precursor to the solution obtained in (b), and stirring for sufficient time for the mixing to be complete; and (d) keeping the solution obtained in (c) in an oven, until the liquid has completely evaporated. The present invention also relates to a deliquescent desiccant material, and to the use of said material for drying gases.

### FIELD OF THE INVENTION

The present invention relates to a method for manufacturing a deliquescent desiccant material, preferably for the dehydration of natural gas, which comprises the steps of (a) preparing a solution comprising water, alcohol, a weak base and a deliquescent salt; (b) stirring the solution obtained in (a) until complete dissolution of the deliquescent salt; (c) adding a silica precursor to the solution obtained in (b), and stirring for sufficient time for the mixing to be complete; and (d) keeping the solution obtained in (c) in an oven, until the liquid has completely evaporated.

The present invention also relates to a deliquescent desiccant material, and to the use of said material for drying gases.

The deliquescent desiccant material of the present invention has ultra-deliquescent capacity, and can be applied, for example, to the gas dehydration/drying field, being particularly useful for reducing the footprint of gas dehydration units in offshore oil platforms.

### BACKGROUND OF THE INVENTION

Many offshore oil platforms bring together, in a relatively small space, a large number of operations, systems and equipment to carry out various activities, such as oil and gas extraction, its primary processing and the control of these processes, among many others.

Given all the complexity of these activities and the high cost of building the platform structure, every square inch of space within the platform needs to be maximized. It is common for platforms that produce natural gas to have a natural gas processing unit, so that the gas can be extracted and treated on the platform, to be sent purified to the coast. These units typically feature equipment for separating liquids and solids from the extracted gas, in addition to the removal of acid gases, dehydration, removal of liquids from natural gas and compression.

Given the difficulties present in the state of the art mentioned above, there is a need to reduce the space occupied on offshore oil platforms, in addition to improving and optimizing drying processes.

The current state of the art mentioned above does not have the unique characteristics that will be presented in detail below.

### BACKGROUND OF THE INVENTION

The deliquescent desiccant material of the present invention achieves ultra-high water capture capacity by combining silica and deliquescent salts in an innovative manner.

This combination had already been studied using mainly the wet impregnation technique. This technique consists of submerging a porous substrate in a solution with deliquescent salts and then removing excess water, so that the salts are confined within the pores of this substrate. This is the strategy by reported the Japanese patents JPW02013069719A1, JP6761999B2, JP2017255331A, JP2010284609A, the Russian patent RU2525178C1 and the international document WO2010082456A7. What varies among these documents is the type of porous substrate used (zeolites, clays, activated carbons, alumina, aluminosilicates) and the type of deliquescent salt (chlorides or bromides of alkali and alkaline earth metals, or hydrophosphates).

Another process also reported involves the reaction of cations present in zeolites with chloride-type anions to form the deliquescent salt within the structure, as reported by documents JP2011161357A and JP5392121B2.

In addition to the impregnation method, it is also possible to functionalize silica with deliquescent salts in situ using the sol-gel method. In this approach, salt is added to the reaction mixture and is present during the formation of the porous substrate, in this case, silica-based.

It is believed that the in situ process has some advantages over impregnation. These include: no obstruction of the porosity of the silica matrices, a simple and straightforward synthesis procedure, and a more homogeneous distribution of the crystals throughout the material. Furthermore, the presence of salt dispersed in the silica matrix increases surface heterogeneity at the atomic level, which contributes to even stronger interactions with water. Gordeeva et al. and Mrowiec-Bialon et al. introduced CaCl₂ in the production of polymeric silica gels and obtained materials with adsorption capacity of up to 1,200 g/kg. These silica gels are normally obtained at acidic pHs or in two-step reactions, producing monoliths.

Regarding desiccant materials and their obtaining methods, the state of the art mentions sol-gel solutions or the use of catalysts, mostly obtained by the Stöber method.

Document from Ruiz-Clavijo A, Hurt A P, Kotha A K and Coleman N J, Effect of Calcium Precursor on the Bioactivity and Biocompatibility of Sol-Gel-Derived Glasses. Feb. 23;10(1): 13 (doi: J Funct Biomater. 2019, 10.3390/jfb10010013), hereinafter Ruiz-Clavijo et al., mentions a process for modifying the Stöber method for producing colloidal silica using different calcium precursors, such as CaCl₂), Ca(NO₃)₂, Ca(OCH₃)₂ and Ca(OCH₅)₂. In its synthesis process, two solutions are produced: the first is composed of tetraethylorthosilicate (TEOS), ethanol and a calcium precursor, among those mentioned. The second solution is composed of water, ethanol and ammonium hydroxide. After preparing the solutions, the first is added to the second and the system remains under stirring for 48 h. To separate the powders formed, centrifugation is performed, followed by 3 washes with deionized water.

The process taught by Ruiz-Clavijo et al. requires the use of two different solutions to obtain the final material, in addition to employing a separation process at the end of the synthesis, which employs centrifugation followed by 3 washes. The process adopted in Ruiz-Clavijo et al. results in a material composed of silica with added calcium only, as observed by the characterization techniques carried out in the article (Energy Dispersive Spectroscopy, EDS, and Fourier Transform Infrared Spectroscopy, FTIR). The anions of the calcium salts used are lost during the centrifugation and washing process, dissolved in the removed solutions.

The Korean patent KR102175902B1 describes a process for producing calcium carbonate whose particles are coated with a silica film, aimed at applications in the cosmetics field. The production process described in KR102175902B1 consists of solubilizing calcium carbonate (CaCO₃) in ethanol, then adding aqueous ammonia solution and, subsequently, tetraethylorthosilicate (TEOS). The process ends with filtration and washing of the solids produced.

Despite starting from similar processes, based on Stöber methods, the process of separating the solids of KR102175902B1 consists of filtration followed by washing, analogous to the process of Ruiz-Clavijo et al., in the sense that parts of the salt are lost in the separated solutions and washing steps. Furthermore, the salt used in KR102175902B1 is not a deliquescent salt: calcium carbonate is not a deliquescent salt like, for example, CaCl₂), presenting little or no performance for water capture.

In the paper of Chen, S., Osaka, A., Hayakawa, S., Shirosaki, Y., Matsumoto, A., Fujii, E., Kawabata, K., & Tsuru, K. (2010), “One-step preparation of organosiloxane-derived silica particles” published in Advances in Bioceramics and Porous Ceramics II—A Collection of Papers Presented at the 33rd International Conference on Advanced Ceramics and Composites (6 ed., Vol. 30, pp. 3-15), hereinafter Chen et al., the production of silica particles containing calcium is reported, using the modified Stöber method. In this process, two separate solutions are produced—one containing water and CaCl₂) and the other containing ethanol and tetraethylorthosilicate (TEOS), which are added to each other and taken to an ultrasound bath after adding ammonia. The resulting particles are separated by centrifugation at 3,500 rpm for 5 min, and then washed with water 3 times. As already mentioned, the centrifugation process followed by washing results in a material with the insertion of only calcium and not the complete deliquescent salt.

On the other hand, in the article written by Greasley, S. J. Page, S. Sirovica, S. Chen, R. A. Martin, A. Riveiro, J. V. Hanna, A. E. Porter and J. R. Jones (hereinafter Greasley et al.) entitled “Controlling particle size in the Stöber process and incorporation of calcium” and published in the Journal of Colloid and Interface Science (2016), describes a synthesis process that consists of producing an initial mixture of ethanol, water and ammonium hydroxide with the subsequent addition of tetraethylorthosilicate (TEOS), forming pure silica particles. The pure silica produced is centrifuged for solid-liquid separation and is redispersed in a solution containing calcium nitrate. After contact between the pure silica and the salt, a new centrifugation takes place. The salt cations and anions are only adsorbed on the surface of the silica particles. Then, the dry powder is fired at 680° C. for 3 h. According to the authors, one of the objectives of burning is to remove the nitrate ions present in the silica.

In Greasley et al., the deliquescent salt is not present in solution before the addition of tetraethylorthosilicate (TEOS), it is added only after the silica particles have already been produced. Despite this, the process described in Greasley et al. also resulted in a homogeneous distribution of calcium throughout the particle, but the authors argue that this was only possible due to the heat treatment carried out, with the aim of removing nitrate ions from the final material, eliminating the presence of these anions.

Finally, the article of Qasim, Mohd and Ananthaiah, J. and Dhara, Surajit and Paik, Pradip and Das, Dibakar, entitled “Synthesis and Characterization of Ultra-Fine Colloidal Silica Nanoparticles”, published in 2014 in the journal Advanced Science, hereinafter referred to as Qasim et al., reports a synthesis process consisting of the following steps: first, a solution of ethanol, ammonia and water is irradiated by ultrasound until the solvents evaporate. Then, a solution of tetraethylorthosilicate (TEOS) in ethanol is added dropwise (0.03 ml/min) and irradiated again for 100 minutes. Then, ammonia is added again dropwise (0.05 ml/min) and the solution is sonicated again for 70 minutes. The solids obtained are dried in an oven by evaporating the solvent in two stages: at 50° C. for 2 hours and then at 150° C. for another 2 hours. The process described in Qasim et al. does not use a deliquescent salt.

Unlike the prior art methods, the inventors of the present invention have developed a method for manufacturing a deliquescent desiccant material from a colloidal route, yielding an ultra-high capacity deliquescent desiccant. The colloidal route is typically achieved at basic pH levels and generates particles that macroscopically have the appearance of powders, without the formation of intermediate gels. Through this route, not reported in the literature, it was possible to produce materials with an ultra-high water capture capacity, which can reach up to 8,300 g/kg.

Among the main technological advantages arising from the method for manufacturing a deliquescent desiccant material of the present invention, one can mention, for example, the ability to process the same amount of gas in a smaller space, compared to prior art materials: deliquescent desiccant material obtained by the method of the present invention captures about 8 kg of water per kg of desiccant, being about twice as efficient as commercial deliquescent desiccants and about 27 times more efficient than solid adsorbents.

In addition to the processing capacity, the method of the present invention has lower cost, as it is capable of processing the same amount of gas in a smaller equipment.

### SUMMARY OF THE INVENTION

Initially, it should be noted that the following description starts from the preferred embodiments of the invention, without being limited by them.

A technical problem addressed by the present invention is the fact that natural gas processing units occupy a lot of space on offshore oil platforms, and it would be ideal to reduce the space occupied.

Therefore, it is an object of the present invention to provide a new process for manufacturing a deliquescent desiccant material, which has ultra-high water capture capacity.

This objective was achieved by a method to manufacture a deliquescent desiccant material, through the association between silica and deliquescent salts, in a colloidal route at alkaline pH and in situ functionalization, which resulted in an deliquescent desiccant material of ultra-high capacity. Said material can be used, for example, as an alternative to absorption and adsorption towers (ethylene glycol, zeolites, activated alumina, silica gel etc.), being able to reduce the footprint of natural gas dehydration units.

### BRIEF DESCRIPTION OF THE FIGURES

To facilitate an easier understanding of the invention, Figures numbered 1, 2 and 3A-3D are provided for illustrative purposes, but without the intention of limiting the invention. These figures accompany this specification and are an integral part of it.

FIG. 1 represents a comparison between deliquescent desiccant materials obtained by the method of the present invention (colloidal route) and a desiccant material obtained as described in the state of the art (gel route). On the left, there are the powders obtained according to the method of the present invention and, on the right, a monolith obtained through the gel route, as described in the state of the art.

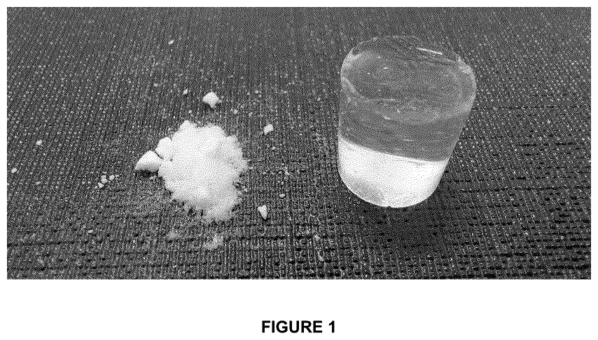

FIG. 2 presents an example of a temperature-programmed water desorption test (sample P306). The black dashed curve (left axis) shows the mass drop recorded by the thermobalance as a function of temperature. The solid black curve (right axis) shows the derivative of the black dashed curve. The gray dotted curve (gray axis on the right) shows the heat absorption or release curve detected in the test. Negative values correspond to heat absorption. Photographs of the sample before (wet) and after (dry) the test are also shown.

FIGS. 3A-3D refer to scanning electron microscopy (SEM) images (FIGS. 3A and 3B) and energy dispersive spectroscopy (EDS) analyzes (FIGS. 3C and 3D), which prove the presence of chlorine, calcium, silicon and oxygen in a deliquescent desiccant material according to the present invention, synthesized with CaCl₂) as deliquescent salt.

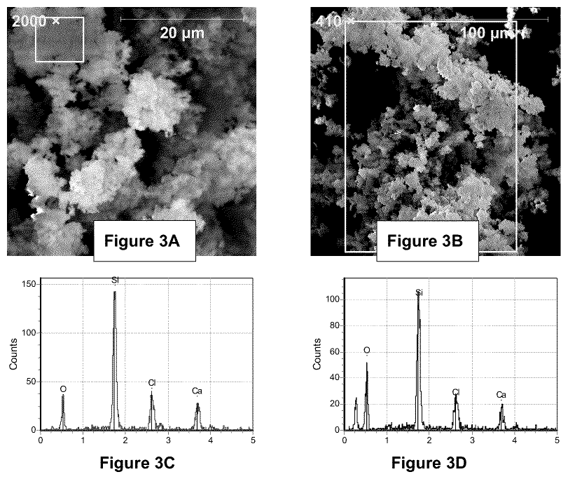

FIG. 4 shows the deliquescent behavior of deliquescent desiccant materials according to the present invention.

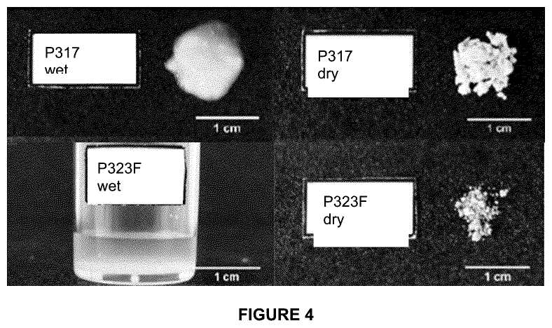

### DETAILED DESCRIPTION OF THE INVENTION

The present invention relates to a method for manufacturing a deliquescent desiccant material, which comprises the steps of:
(a) preparing a solution comprising water, alcohol, a weak base and a deliquescent salt;
(b) stirring the solution obtained in (a) until complete dissolution of the deliquescent salt;
(c) adding a silica precursor to the solution obtained in (b), and stirring for sufficient time for the mixing to be complete; and
(d) keeping the solution obtained in (c) in an oven, until the liquid has completely evaporated.

In a preferred embodiment of the method for making a deliquescent desiccant material of the present invention, the molar ratio of water: alcohol: weak base: deliquescent salt:silica precursor is in the range of approximately 10-40 water: 20-50 alcohol: 1-4 weak base: 0.01-3 deliquescent salt:1 silica precursor. More preferably, the molar ratio of water: alcohol: weak base: deliquescent salt: silica precursor is 16 water:24 alcohol:2 weak base:0.25 deliquescent salt:1 silica precursor.

The alcohol suitable for the method of manufacturing a deliquescent desiccant material of the present invention can be any straight-chain alcohol, preferably ethanol, methanol and mixtures thereof.

A “weak base” according to the method for making a deliquescent desiccant material of the present invention can be understood as bases with a low dissociation constant, that is, which do not completely dissociate in contact with water. Preferably, the weak base is selected from decomposed compounds based on primary, secondary and tertiary amines, and mixtures thereof. More preferably, the weak base is ammonium hydroxide.

A deliquescent salt suitable for a method of manufacturing a deliquescent desiccant material of the present invention can be selected from calcium, magnesium, sodium, potassium, lithium and cobalt chlorides, bromides, nitrates, sulfates, chromates, acetates or fluorides, among others. Preferably, the deliquescent salt is selected from calcium chloride, aluminum sulfate, magnesium chloride, cobalt chloride and mixtures thereof.

A silica precursor suitable for a method for manufacturing a deliquescent desiccant material of the present invention can be selected from alkoxysilanes, such as tetramethylorthosilicate (TMOS) and tetraethylorthosilicate (TEOS), sodium silicate, and mixtures thereof.

In a preferred embodiment, in step (c) of the method for manufacturing a deliquescent desiccant material of the present invention, the solution is stirred at a temperature of 20° C. to 60° C., for a sufficient period of time ranging from 1 hour to 72 hours.

In a preferred embodiment, in step (d) of the method for manufacturing a deliquescent desiccant material of the present invention, the solution is maintained at a temperature of 50° C. to 100° C., for a period of time of approximately 1-30 days.

In addition to a method for manufacturing a deliquescent desiccant material of the present invention, the present invention also relates to a deliquescent desiccant material.

Unlike similar materials in the state of the art, the deliquescent desiccant material of the present invention comprises silica, and at least one cation and one anion originating from a deliquescent salt. For example, the deliquescent desiccant material obtained by the process of the present invention, in which CaCl₂ was used as the deliquescent salt, will maintain the ions Ca²⁺ and Cl⁻ in its structure.

Additionally, the deliquescent desiccant material of the present invention has a surface area in excess of 10 m²/g, such as between 10 m²/g to 400 m²/g, preferably from 10 m²/g to 100 10 m²/g, and more preferably, from 10 m²/g to 42 m²/g.

The deliquescent desiccant material of the present invention can be used for drying gases.

### Examples Method for Manufacturing a Deliquescent Desiccant Material

In a non-limiting example of an embodiment of the method for manufacturing a deliquescent desiccant material of the present invention, a solution of distilled water, ethanol, ammonium hydroxide and calcium chloride was prepared, which was stirred at about 30° C. until complete dissolution of the calcium chloride. Then, tetraethylorthosilicate (TEOS) was added to the mixture, which was stirred for approximately 24 h, at a temperature between 20° C. and 60° C. After complete mixing, the obtained solution was dried in an oven, at a temperature of approximately 60° C., until complete evaporation of the liquid. The molar ratios used were:

$$1 TEOS : 16 {H}_{2} O : 2 N {H}_{4} O H : 24 E t O H : 0 , 25 C a C {l}_{2}$$

After obtaining the deliquescent desiccant material by the method of the present invention, the material can undergo mechanical shaping processes. By way of illustration, different possibilities were tested, which are described below:

### Extrusion Followed by Cutting

The pastes were prepared by mixing synthesized samples in the form of dry powders, Methocel® (A4M) as a binder and plasticizer (10-20% by weight) and deionized water. First, the dry components (powder+binder) were intensively mixed and then a minimum amount of deionized water was added to the dry mixture until forming an uniform and consistent mass. The wet paste was then transferred to a metal screw extruder fitted with a die of 3.8 mm diameter circular cross-section. The extrusion was performed by constantly moving the screw manually. Extrudates of 6 mm length were cut using a nickel-coated knife. The wet extrudates were dried overnight at 60° C.

### Pressing

1 g of synthesized sample in dry powder form was mixed with 20% by weight of Methocel® (A4M) and 0.6 ml of deionized water. Then, the mixture was placed in a cylindrical mold and pressed with 1 ton of load under vacuum, maintaining the pressure for a period of time between 2 and 3 minutes. The press used was a SPECAC 15 manual hydraulic press. The tablets obtained were dried at 60° C. for 8 hours.

### Deliquescent Desiccant Materials

Several deliquescent desiccant materials, as per the method of this invention, were produced, involving variations in the synthesis conditions of the starting materials.

For these samples, distilled water, ethanol (EtOH) as alcohol, ammonium hydroxide as weak base, calcium chloride (CaCl₂) as deliquescent salt, and tetraethylorthosilicate (TEOS) as precursor of silica, were used.

In Table 1 below, various compositions of the deliquescent desiccant material of the present invention are provided, in which the ratios of the starting materials have been changed. Columns 2-4 of Table 1 present the molar ratio values between the indicated reagents, and column 5 of Table 1 presents the temperature at which the reaction mixture was maintained during the stirring period.

TABLE 1

| Samples | CaCl₂/TEOS | Water/TEOS | EtOH/TEOS | Temp. (° C.) |
|---|---|---|---|---|
| P306 | 0.25 | 16 | 24 | 30 |
| P315 | 1 | 16 | 24 | 30 |
| P316 | 2 | 16 | 24 | 30 |
| P317 | 0.25 | 24 | 24 | 30 |
| P318 | 0.25 | 32 | 24 | 30 |
| P319 | 0.25 | 16 | 36 | 30 |
| P320 | 0.25 | 16 | 48 | 30 |
| P322 | 0.25 | 16 | 24 | 50 |
| P323 | 0.25 | 16 | 24 | 30 |
| P323F | 0.25 | 16 | 24 | 30 |

### Thermogravimetry Assay

Samples of a deliquescent desiccant material according to the present invention were hydrated in a sealed desiccator with a film of water on the bottom (100% relative humidity), at room temperature (about 25° C.), for at least one week.

Next, the samples were moved to the thermogravimetric analysis equipment, comprising a compact furnace with a regulated atmosphere, where an alumina crucible is placed to hold the sample for analysis. This crucible is positioned on a highly sensitive balance.

Within this equipment, controlled and monitored drying of the samples was carried out. For said drying, an inert atmosphere is placed (nitrogen flow (20 mL/min), and the temperature inside the oven is gradually increased (from 30° C. to 500° C., at 10° C./min).

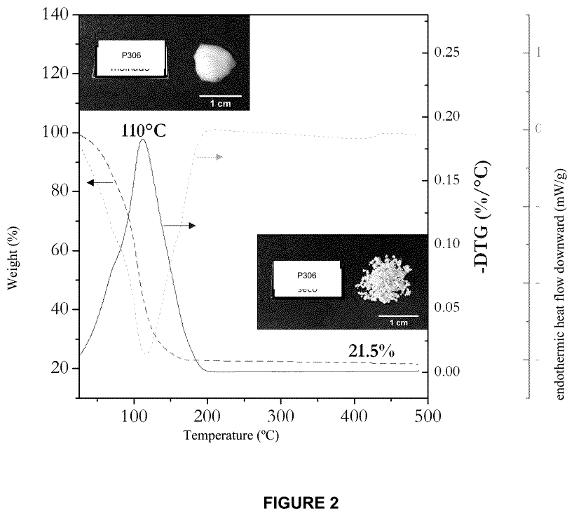

As the assay progresses, the water captured by the sample is released, resulting in mass loss. This mass loss is recorded continuously, which results in the graph shown in FIG. 2.

From the amount of mass lost up to the maximum test temperature (500° C.), the amount of water that was captured by the sample during the hydration stage is calculated. For example, if the sample had a final (dry) mass of 21.5% of the initial (wet) mass, this means that 78.5% of the mass released in the test was water. Therefore, considering the dry mass as 100%, the wet mass becomes 371%. In this way, the adsorption capacity value of 3, 643 g/kg is reached, shown in the last column of Table 2.

The other parameter shown in Table 2 is the Maximum Desorption Rate Temperature (MDRT). This temperature is obtained as follows. The derivative of the mass drop curve obtained in the test is taken (black dashed curve), resulting in the solid black curve shown in FIG. 2. This derivative has a maximum value in the case of this test, which occurs at a temperature of 110° C. for the sample in FIG. 2. This indicates that the rate of mass drop (or water desorption) is maximum at this temperature, which bring information about the temperature required for the material desorption/drying/regeneration process.

The samples and results are as shown in Table 2 below:

TABLE 2
Adsorption capacities and Maximum Desorption Rate
Temperature (MDRT) for variations of the deliquescent
desiccant material of the present invention and commercial
desiccants. Values obtained from the programmed temperature
water desorption test.

| Type | | | Adsorption |
|---|---|---|---|
| of | | | capacity |
| desiccant | Sample | MDRT (° C.) | (g/kg) |
| Present | P306 | 110 | 3,643 |
| invention | P315 | 115 | 5,049 |
| | P316 | 110 | 6,147 |
| | P317 | 115 | 4,581 |
| | P318 | 113 | 4,431 |
| | P319 | 115 | 4,125 |
| | P320 | 93 | 2,870 |
| | P322 | 110 | 4,356 |
| | P323 | 90 | 2,658 |
| | P323F | 100 | 8,310 |
| Commercial | NaY | 130 | 353 |
| zeolites | A | 160 | 348 |
| | VA-4ª | 178 | 332 |
| | GC-3ª | 178 | 260 |
| Commercial | Silica gel | 100 | 272 |
| silica gels | VA-SiG | 100 | 474 |
| | VA-SiGB | 110 | 352 |
| Commercial | VA-SP | 180 | 1,322 |
| deliquescent | VA-GDM | 170 | 1,887 |
| desiccants | VA-DOL | 95 | 3,630 |

### Surface Area of Deliquescent Desiccant Materials

Table 3 below lists examples of surface area (m/g) of some deliquescent desiccant materials according to the present invention. The areas were obtained through nitrogen adsorption, using the BET equation.

TABLE 3
Examples of surface area (m²/g)

| Samples | Surface area (m²/g) |
|---|---|
| P306 | 14 |
| P315 | 21 |
| P318 | 15 |
| P319 | 17 |
| P320 | 18 |
| P323 | 19 |
| P323F | 42 |

### Water Capture Capacity (Adsorption)

Table 4 below lists the water capture capacity above 3,000 g/kg under conditions of 25° C. and 100% relative humidity. Examples of water capture capacities obtained for the samples of the invention are given in Table 2 below.

TABLE 4
Adsorption capacities for variations of the
deliquescent desiccant material
according to the present invention

| Desiccant deliquescent | Adsorption |
|---|---|
| material | capacity (g/kg) |
| P306 | 3,643 |
| P315 | 5,049 |
| P316 | 6,147 |
| P317 | 4,581 |
| P318 | 4,431 |
| P319 | 4,125 |
| P320 | 2,870 |
| P322 | 4,356 |
| P323F | 8,310 |

The skilled in the art will value the knowledge presented herein and can reproduce the invention in the presented embodiments and their variants, which are covered in the scope of the claims below.

1. METHOD FOR MANUFACTURING A DELIQUESCENT DESICCANT MATERIAL, characterized in that it comprises the steps of:
(a) preparing a solution comprising water, alcohol, a weak base and a deliquescent salt;
(b) stirring the solution obtained in (a) until complete dissolution of the deliquescent salt;
(c) adding a silica precursor to the solution obtained in (b), and stirring for sufficient time for the mixing to be complete; and
(d) keeping the solution obtained in (c) in an oven, until the liquid has completely evaporated.

2. METHOD, according to claim 1, characterized in that the molar ratio between water:alcohol:weak base:deliquescent salt:silica precursor is in the range of 10-40 water:20-50 alcohol: 1-4 weak base:0.01-3 deliquescent salt:1 silica precursor.

3. METHOD, according to claim 2, characterized in that the molar ratio between water:alcohol:weak base:deliquescent salt:silica precursor is preferably 16 water:24 alcohol:2 weak base:0.25 deliquescent salt: 1 silica precursor.

4. METHOD, according to claim 1, characterized in that alcohol is selected from ethanol, methanol and mixtures thereof.

5. METHOD, according to claim 1, characterized in that the weak base is selected from compounds based on primary, secondary and tertiary amines, and a mixture thereof, preferably ammonium hydroxide.

6. METHOD, according to claim 1, characterized in that the deliquescent salt is selected from calcium, magnesium, sodium, potassium, lithium, cobalt chlorides, bromides, nitrates, sulfates, chromates, acetates or fluorides, preferably from calcium chloride, aluminum sulfate, magnesium chloride, cobalt chloride and mixtures thereof.

7. METHOD, according to claim 1, characterized in that the silica precursor is selected from alkoxysilanes, preferably tetramethylorthosilicate (TMOS) and tetraethylorthosilicate (TEOS), sodium silicate, and mixtures thereof.

8. METHOD, according to claim 1, characterized in that, in step (b), the solution is stirred at a temperature of 10-40° C.

9. METHOD, according to claim 1, characterized in that, in step (c), the solution is stirred at a temperature of 20-60° C., for a sufficient period ranging from 1-72 hours.

10. METHOD, according to claim 1, characterized in that, in step (d), the solution is maintained at a temperature of 50-100° C., for a period from 1-30 days.

11. DELIQUESCENT DESICCANT MATERIAL, characterized in that it comprises silica, cation and anion of a deliquescent salt, and by having a surface area above 10 m²/g.

12. MATERIAL, according to claim 11, characterized in that it has a surface area of 10-400 m²/g.

13. USE OF A DELIQUESCENT DESICCANT MATERIAL, as defined in claim 11, characterized in that it is for drying gases.

14. USE OF A DELIQUESCENT DESICCANT MATERIAL, obtained by the method as defined in claim 1, characterized in that it is for drying gasses.
